(19) United States
(12) Patent Application Publication
(10) Pub. No.: US 2013/0159082 A1
(43) Pub. Date: Jun. 20, 2013

(54) MANAGING ELECTRONIC MAIL

(71) Applicants: ALLISON ABBOTT, WEST CHESTER, PA (US); JOHN ZANKOWSKI, OAKLYN, NJ (US); JUSTIN GRAVANTE, AUDUBON, NJ (US); JESSE MULLEN, BENSALEM, PA (US); ANTHONY WOJCIECHOWSKI, PHILADELPHIA, PA (US)

(72) Inventors: ALLISON ABBOTT, WEST CHESTER, PA (US); JOHN ZANKOWSKI, OAKLYN, NJ (US); JUSTIN GRAVANTE, AUDUBON, NJ (US); JESSE MULLEN, BENSALEM, PA (US); ANTHONY WOJCIECHOWSKI, PHILADELPHIA, PA (US)

(73) Assignee: COMCAST CABLE COMMUNICATIONS, LLC, PHILADELPHIA, PA (US)

(21) Appl. No.: 13/328,667

(22) Filed: Dec. 16, 2011

(51) Int. Cl. G06F 15/16; G06Q 30/02

(52) U.S. Cl. 705/14.25; 709/206; 705/14.1

(57) ABSTRACT

Methods, systems, computer readable media, and apparatuses for managing electronic mail are presented. In one arrangement, a plurality of incoming emails from a first user's inbox may be displayed. An option to designate an email as a series publication may also be displayed. In response to receiving a selection of the option while at least one email is selected, a new email folder dedicated to a series publication contained in the at least one email may be automatically created. Subsequently, subsequent emails containing future issues of the series publication may be redirected to the new email folder.

### BACKGROUND

Electronic mail or “email” is becoming an increasingly popular mode of communication as larger numbers of people are able to use computers and access the Internet. In addition to providing a way for individuals to communicate more efficiently with each other, electronic mail also provides an effective form of communication for businesses, organizations, and other entities interested in communicating with large groups of people, such as current and potential customers. As the popularity of electronic mail continues to grow, it is desirable to provide computer users with more convenient and functional ways of managing electronic mail messages.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure relate to managing electronic communications, such as email. In particular, various aspects of the disclosure relate to identifying and sorting electronic mail messages that include series publications, offering users access to new subscription-based electronic series publications, categorizing electronic mail messages that include series publications, and displaying electronic mail messages that include other types of enhanced content, such as preview content like movie trailers, sample song downloads, virtual fitting rooms, and more.

For example, in one method of identifying and sorting electronic mail messages that include series publications, a plurality of incoming emails from a user's inbox may be displayed (e.g., by a computing device, such as the user's desktop, laptop, or tablet computer). Subsequently, an option to designate an email as a series publication (e.g., a periodical newsletter) may be displayed. In response to receiving a selection of the option from the user while an email in the inbox is selected, a new email folder dedicated to a series publication contained in the email may be automatically created. Going forward, subsequent emails containing future issues of the series publication may be redirected to that newly created email folder.

In one variation of this method, in addition to the other steps discussed above, one or more new subscription-based offers (e.g., offers to subscribe to other electronic series publications in which the user may be interested) may be displayed to the user. In another variation of the method, when a user designates an email as a series publication and the computing device creates a dedicated folder, the computing device also may prompt the user to categorize the series publication. For instance, the user may categorize the series publication as being related to fashion, shopping, electronics, sports, and/or other categories that are described below. In yet another variation of the method, an email may include enhanced content in the form of a preview, such as a movie trailer or a virtual fitting room, and the computing device may display the email's message and, if the user so desires, subsequently display the preview included in the email.

### BRIEF DESCRIPTION OF THE DRAWINGS

The present disclosure is illustrated by way of example and not limited in the accompanying figures in which like reference numerals indicate similar elements and in which:

FIG. 1 illustrates an example information distribution network according to one or more aspects described herein.

FIG. 2 illustrates an example hardware platform on which the various elements described herein may be implemented according to one or more aspects described herein.

FIGS. 3A-3B illustrate an example method of managing electronic mail according to one or more aspects described herein.

FIGS. 4-10 illustrate example user interfaces for managing electronic mail according to one or more aspects described herein.

FIG. 11 illustrates an example method for controlling the preview.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

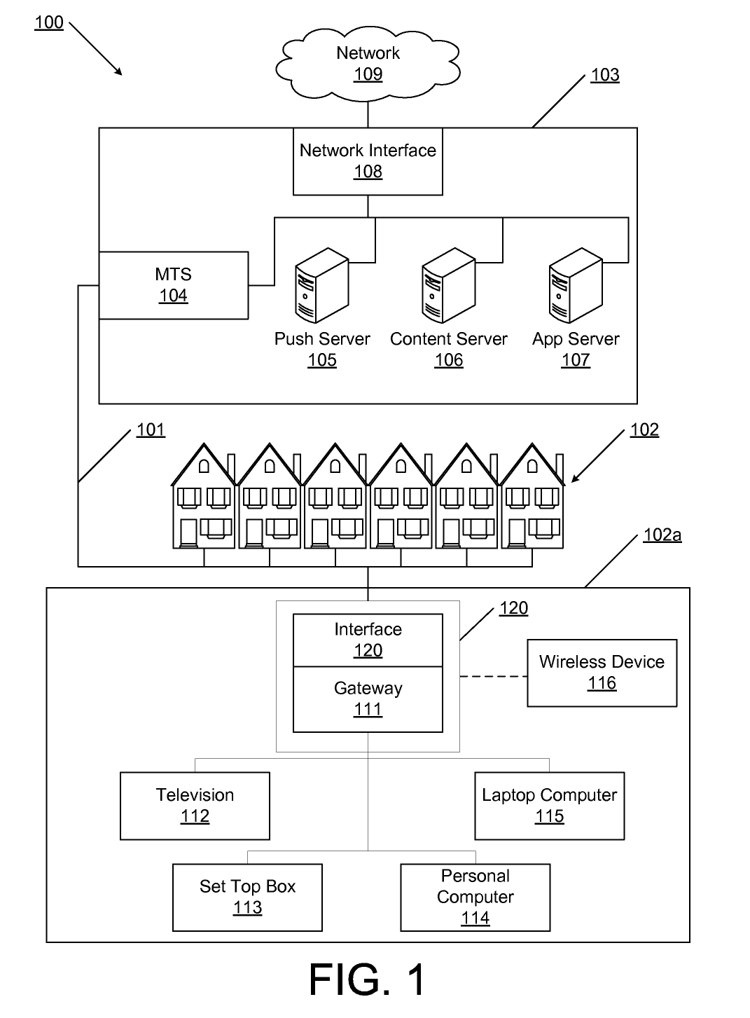

FIG. 1 illustrates an example information distribution network 100 in which many of the various features described herein may be implemented. Network 100 may be any type of information distribution network, such as satellite, telephone, cellular, wireless, etc. One example may be an optical fiber network, a coaxial cable network, or a hybrid fiber/coax distribution network. Such networks 100 use a series of interconnected communication lines 101 (e.g., coaxial cables, optical fibers, wireless, etc.) to connect multiple premises 102 (e.g., businesses, homes, consumer dwellings, etc.) to a central office or headend 103. The central office 103 may transmit downstream information signals onto the lines 101, and each home 102 may have a receiver used to receive and process those signals.

There may be one line 101 originating from the central office 103, and it may be split a number of times to distribute the signal to various premises, such as homes 102, in the vicinity (which may be many miles) of the central office 103. The lines 101 may include components not illustrated, such as splitters, filters, amplifiers, etc. to help convey the signal clearly, but in general, each split may introduce a bit of signal degradation. Portions of the lines 101 may also be implemented with fiber-optic cable, while other portions may be implemented with coaxial cable, other lines, or wireless communication paths.

The central office 103 may include a communication interface 104, such as a cable modem termination system (CMTS), which may be a computing device configured to manage communications between devices on the network of lines 101 and backend devices such as servers 105-107 (to be discussed further below). The interface 104 may be as specified in a standard, such as the Data Over Cable Service Interface Specification (DOCSIS) standard, published by Cable Television Laboratories, Inc. (a.k.a. CableLabs), or it may be a similar or modified device instead. The interface 104 may be configured to place data on one or more downstream frequencies to be received by modems at the various homes 102, and to receive upstream communications from those modems on one or more upstream frequencies. The central office 103 may also include one or more network interfaces 108, which can permit the central office 103 to communicate with various other external networks 109. These networks 109 may include, for example, networks of Internet devices, telephone networks, cellular telephone networks, fiber optic networks, local wireless networks (e.g., WiMAX), satellite networks, and any other desired network, and the interface 108 may include the corresponding circuitry needed to communicate on the network 109, and to other devices on the network such as a cellular telephone network and its corresponding cell phones.

As noted above, the central office 103 may include a variety of servers 105-107 that may be configured to perform various functions. For example, the central office 103 may include a push notification server 105. The push notification server 105 may generate push notifications to deliver data and/or commands to the various homes 102 in the network (or more specifically, to the devices in the homes 102 that are configured to detect such notifications). The central office 103 may also include a content server 106. The content server 106 may be one or more computing devices that are configured to provide content to users in the homes 102. This content may be, for example, video on demand movies, television programs, songs, text listings, Internet pages, other data, etc. The content server 106 may include software to validate user identities and entitlements, locate and retrieve requested content, encrypt the content, and initiate delivery (e.g., streaming) of the content to the requesting user and/or device.

The central office 103 may also include one or more application servers 107. An application server 107 may be a computing device configured to offer any desired service, and may run various languages and operating systems (e.g., servlets and JSP pages running on Tomcat/MySQL, OSX, BSD, Ubuntu, Redhat, HTML5, JavaScript, AJAX and COMET). For example, an application server may be responsible for collecting television program listings information and generating a data download for electronic program guide listings. Another application server may be responsible for monitoring user viewing habits and collecting that information for use in selecting advertisements. Another application server may be responsible for formatting and inserting advertisements in a video stream being transmitted to the homes 102. And as will be discussed in greater detail below, another application server may be responsible for sending, receiving, and/or otherwise processing electronic mail messages.

An example premises 102a, such as a home, may include an interface 120. The interface 120 may comprise a modem 110, which may include transmitters and receivers used to communicate on the lines 101 and with the central office 103. The modem 110 may be, for example, a coaxial cable modem (for coaxial cable lines 101), a fiber interface node (for fiber optic lines 101), or any other desired modem device. The modem 110 may be connected to, or be a part of, a gateway interface device 111. The gateway interface device 111 may be a computing device that communicates with the modem 110 to allow one or more other devices in the home to communicate with the central office 103 and other devices beyond the central office. The gateway 111 may be a set-top box (STB), digital video recorder (DVR), computer server, or any other desired computing device. The gateway 111 may also include (not shown) local network interfaces to provide communication signals to devices in the home, such as televisions 112, additional STBs 113, personal computers 114, laptop computers 115, wireless devices 116 (wireless laptops and netbooks, mobile phones, mobile televisions, personal digital assistants (PDA), tablet computers, etc.), and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11), Bluetooth interfaces, and others.

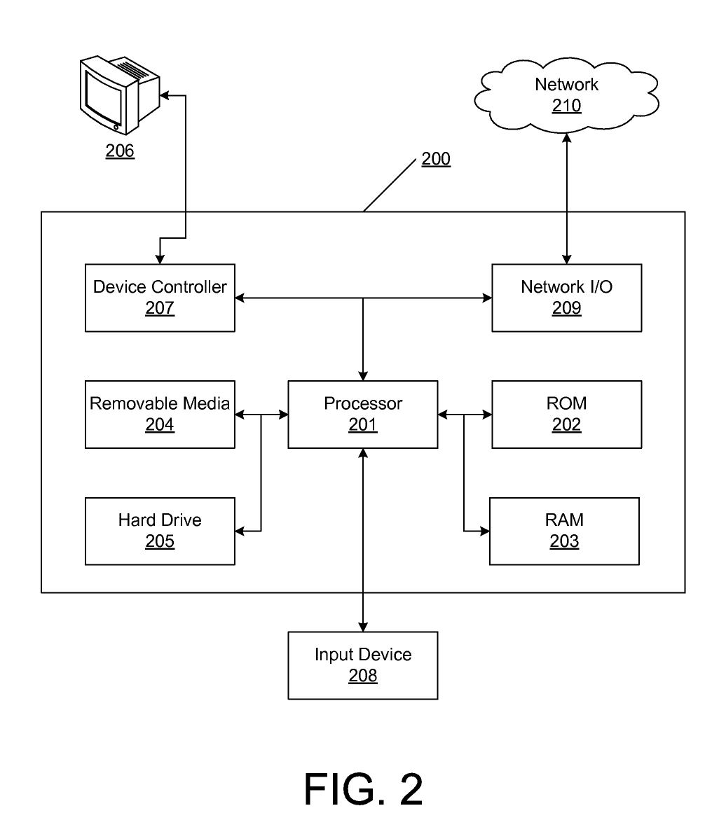

FIG. 2 illustrates general hardware elements that can be used to implement any of the various computing devices discussed above. The computing device 200 may include one or more processors 201, which may execute instructions of a computer program to perform any of the features described herein. The instructions may be stored in any type of computer-readable medium or memory, to configure the operation of the processor 201. For example, instructions may be stored in a read-only memory (ROM) 202, random access memory (RAM) 203, removable media 204, such as a Universal Serial Bus (USB) drive, compact disk (CD) or digital versatile disk (DVD), floppy disk drive, or any other desired electronic storage medium. Instructions may also be stored in an attached (or internal) hard drive 205. The computing device 200 may include one or more output devices, such as a display 206 (or an external television), and may include one or more output device controllers 207, such as a video processor. There may also be one or more user input devices 208, such as a remote control, keyboard, mouse, touch screen, microphone, etc. The computing device 200 may also include one or more network interfaces, such as input/output circuits 209 (such as a network card) to communicate with an external network 210. The network interface may be a wired interface, wireless interface, or a combination of the two. In some embodiments, the interface 209 may include a modem (e.g., a cable modem), and network 210 may include the communication lines 101 discussed above, the external network 109, an in-home network, a provider's wireless, coaxial, fiber, or hybrid fiber/coaxial distribution system (e.g., a DOCSIS network), or any other desired network.

Various features described herein may allow electronic communication, such as email, to be managed, for example, for users accessing content from the central office 103 or other networks. For instance, one such user may be a viewer who is watching a television program being transmitted from the central office 103 or any content provider, while another user could be viewing an Internet Protocol (IP) stream of a video program from a video server at the central office 103 (or elsewhere). Still another user could be browsing web pages available via a network such as the Internet and/or reading electronic mail messages using a computing device, such as personal computer 114, laptop computer 115, or wireless device 116. These and other aspects of the disclosure will be described in detail below.

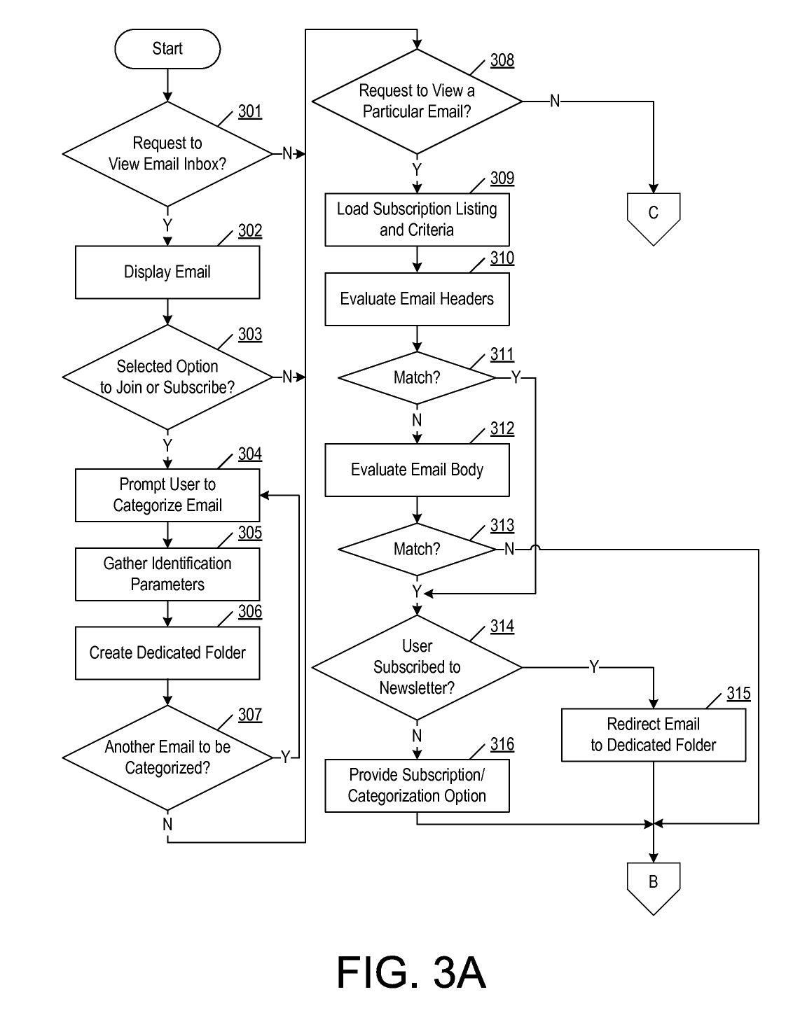

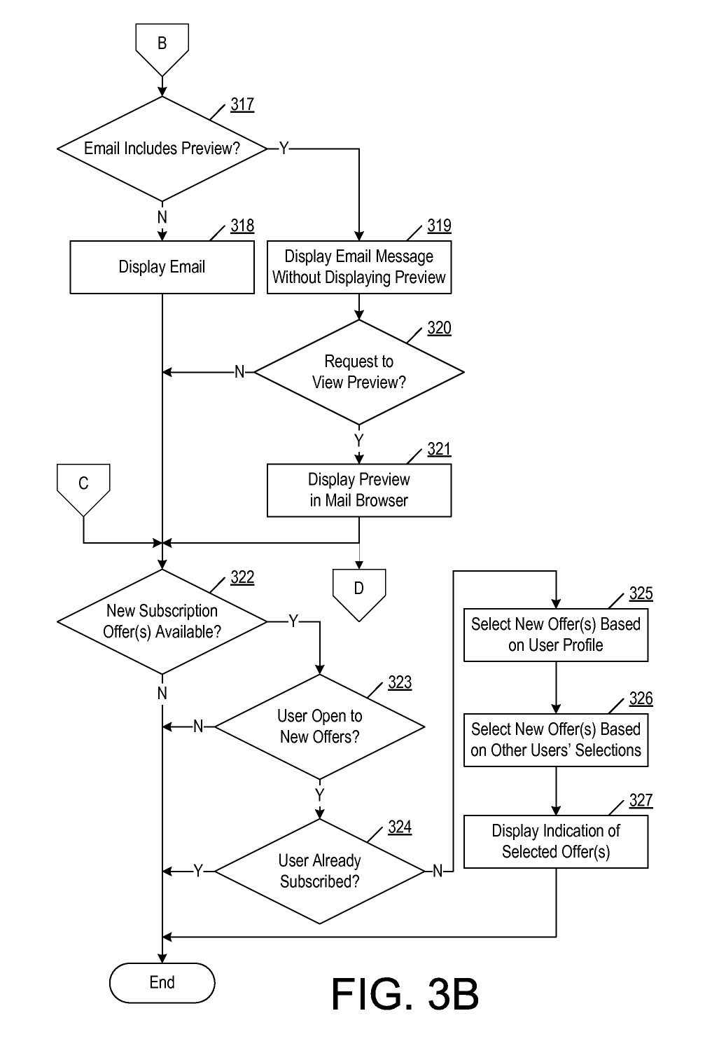

FIG. 3A illustrates an example method of managing electronic communications according to one or more aspects described herein. One example of an electronic communication is email. Herein, reference is often made to email for convenience of description. However, where reference is made to email, it should be understood that other electronic communications may be substituted.

In one or more arrangements, the example method of FIG. 3A may be performed by a computing device such as a server (e.g., an email server and/or application server 107 operated by a service provider at central office 103). In one or more alternative arrangements, one or more steps of this example method may be performed by a user's computing device (e.g., personal computer 114, which may be located at premises 102a). Additionally or alternatively, in the description of various steps below where a user interface or the like is described as being displayed, such description may encompass causing the displaying of such a user interface or the like on a display device incorporated into, connected to, and/or otherwise in communication with a computing device (e.g., a display on a mobile device such as a smart phone, a video monitor connected to personal computer 114 or a liquid crystal display screen incorporated into laptop computer 115, etc.).

In step 301, it may be determined whether a user requested to view an email inbox. For example, in step 301, a user's computing device, such as personal computer 114, may determine whether it has received user input corresponding to a request from a user thereof to view an email inbox, or another database or memory location storing email. The email inbox may be a folder (e.g., a static folder, virtual folder, etc.) in which electronic mail messages or “emails” received by the computing device (and/or received by a mail server on behalf of the user) are stored. In one or more arrangements, this user input may be received by the computing device (e.g., personal computer 114) as a command to launch and/or display a mail application or the like (e.g., a web-based mail application or portal).

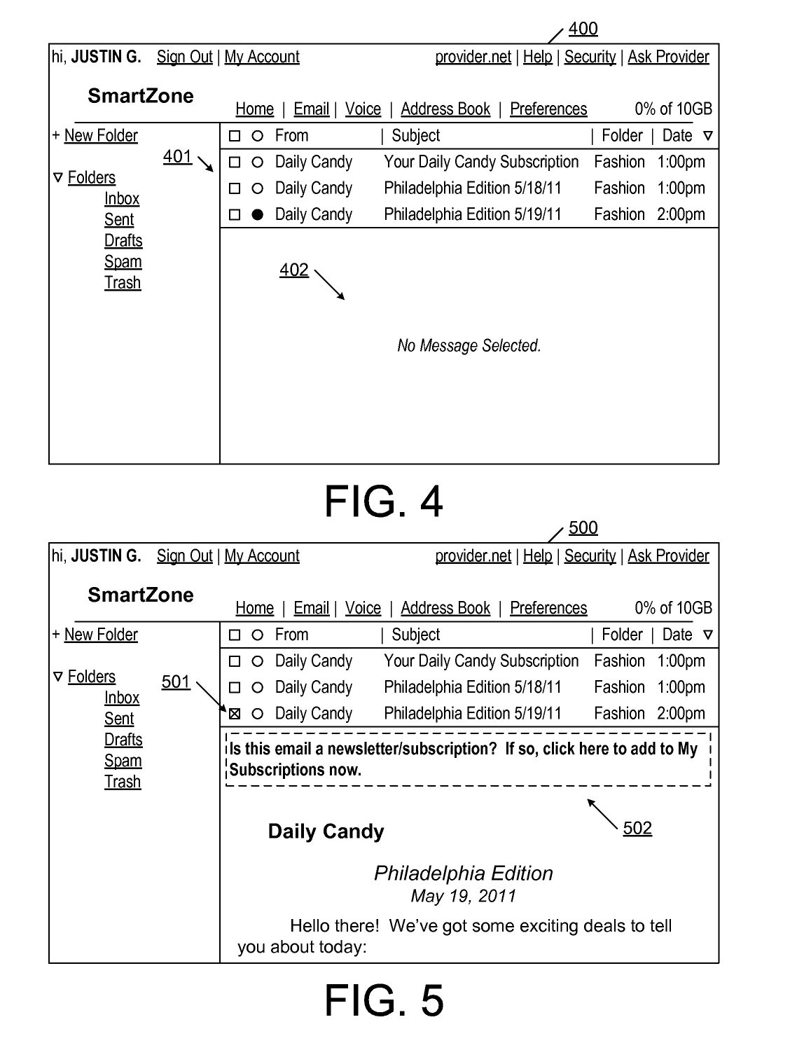

If it is determined, in step 301, that user input corresponding to a request to view an email inbox has been received, then in step 302, a list of email may be displayed. For example, in step 302, the computing device may display (and/or cause to be displayed by another device) a user interface that includes a list of emails and/or the contents thereof that are associated with the user's inbox. Such a user interface may, for instance, resemble example user interface 400, which is illustrated in FIG. 4.

As may be seen in FIG. 4, user interface 400 may include one or more menu bars, tool bars, and/or navigation pages via which a user can provide user input to the computing device (e.g., personal computer 114) and/or via which a user may be able to navigate one or more emails and/or email folders. For example, user interface 400 may include a message listing 401 in which envelope information for one or more emails is displayed. Such envelope information may include a status indicator which indicates whether or not the message has been read (and/or marked as unread), the name and/or email address of the sender of the email, the subject of the email, a folder (or sub-folder) in which the email may be classified and/or stored, as well as the date the email was sent and/or received. In some arrangements, other fields and/or types of information may be displayed in place of, and/or in addition to, any and/or all of these types of envelope information. Additionally or alternatively, user interface 400 may include a reading pane 402 in which the contents of one or more emails may be displayed (e.g., when such emails are selected by a user via the user interface).

Referring again to FIG. 3A, the example method of managing electronic communications may manage subscriptions. Herein, use of the words “subscription,” “subscribe,” and the like does not require, but may include, paying for a service, and thus, any opt-in service may be a subscription. In step 303, it may be determined whether a user has selected an option to subscribe to, or otherwise join or have access to, one or more email series publications. For example, the computing device may display a user interface that includes a button or menu option to designate one or more emails as including a series publication and/or to request to subscribe to the series publication(s) included in the email(s), and the computing device may determine, in step 303, whether user input corresponding to a selection of the button or menu option was received. Such a user interface may, for instance, resemble example user interface 500, which is illustrated in FIG. 5.

As may be seen in FIG. 5, in user interface 500, a user may have selected a message from the message listing to be displayed in the message reading pane (e.g., by activating or otherwise selecting the message and/or checkbox 501, which may correspond to the displayed message). In addition, the computing device may have identified the selected message as possibly including a series publication (e.g., a periodical newsletter), and thus determined to display option 502, which may prompt the user to provide user input indicating whether or not the selected message includes a series publication. In one or more alternative arrangements, the computing device may display option 502 with respect to any and/or all of the emails in the user's inbox (e.g., without regard to whether or not the computing device has identified a particular message as possibly including a periodical series publication).

In one or more arrangements, a computing device (e.g., personal computer 114) may identify an email as possibly including a series publication (e.g., a periodical newsletter) by analyzing the email's content, envelope information, and/or other header information. For example, the computing device may examine the email's content (e.g., header, subject line, message body, sender, recipient, addressee, etc.) and determine whether the email includes the words “subscribe,” “unsubscribe,” “newsletter,” “publication,” and/or other words which may be indicative of a series publication. In another example, the computing device may examine the email's envelope information and determine whether the email includes the current date or month in the title, which may be indicative of a series publication. In still another example, the computing device may examine the email's header information and determine whether the email was sent from an address or server known to be associated with series publications. In this example, the computing device may, for instance, compare such header information to information about known series publications stored on the computing device (e.g., in a user's local address book) and/or stored on a remote memory device or server, such as application server 107. In some arrangements, such a remote server may aggregate information about many series publications received by a plurality of users, analyze the aggregated information to determine common identifying features of particular series publications, store information about these common identifying features in a database, and allow various computing devices to access the stored information to facilitate determining whether particular emails include series publications. Additionally or alternatively, the information about these common identifying features stored in the database may include user preferences set by other users as to how particular series publications may be identified. For instance, if a first set or a particular number of users (e.g., more than ten) have marked a particular email (or, e.g., emails from a particular sender) as being a series publication, this information might be stored in a database accessed by one or more computing devices of other users, such that the computing devices of the other users might automatically flag the email as a series publication based on the marking of the email as a series publication made by the first set of users.

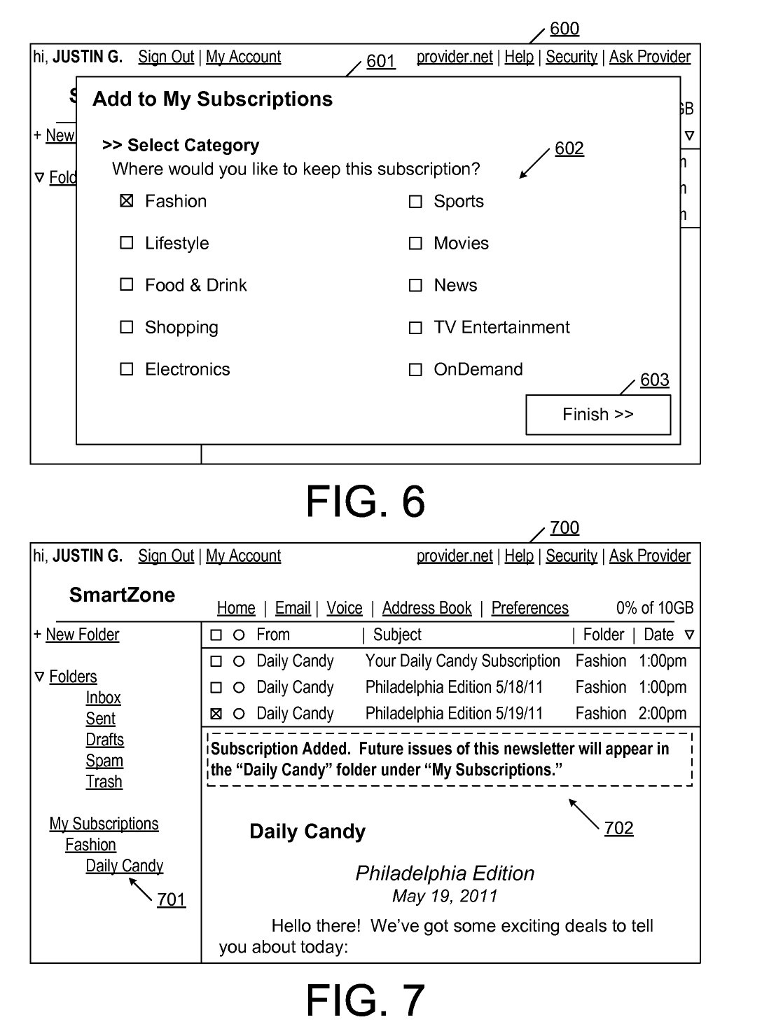

Referring again to FIG. 3A, if it is determined in step 303, that the user has selected an option to receive or subscribe to one or more email series publications, then in step 304, the user may be prompted to categorize at least one of the emails with respect to which the option to receive or subscribe was selected. In one or more arrangements, a computing device may prompt a user in this manner by displaying a user interface that includes a dialog box. Such a user interface may, for instance, resemble example user interface 600, which is illustrated in FIG. 6.

As may be seen in FIG. 6, user interface 600 may include a dialog box 601 via which a user may be prompted to categorize one or more series publications. For example, dialog box 601 may include a plurality of selectable checkboxes 602, and by selecting (and/or deselecting) one or more checkboxes included in the plurality of selectable checkboxes 602, a user may be able to specify that a particular series publication is associated with one or more particular categories (and should be categorized by the computing device, for instance, in the same manner). Possible categories may include, for example, “Fashion,” “Lifestyle,” “Food & Drink,” “Shopping,” “Electronics,” “Sports,” “Movies,” “News,” “TV Entertainment,” and “On Demand.” Any other desirable categories also may be included in place of, or in addition to, the example categories discussed here. Additionally or alternatively, a user may be able to add to and/or edit the one or more categories. Once the user has made his or her selections, the user may click on or otherwise select finish button 603, at which point the computing device may, for example, save the user's category selections for the one or more series publications being categorized. By categorizing the particular email and/or series publication included therein, the computing device subsequently may be able to display (and the user may be able to view) the various subscribed series publications sorted by category. In some arrangements, categorizing series publications in this manner further may allow the computing device to deliver additional series publications to the user with respect to which the user might not be subscribed, but in which the user might be interested. For instance, if a user has subscribed to multiple series publications of a particular category (e.g., more than a predetermined number of “Electronics” series publications), the computing device may determine that the user has an interest in series publications of the particular category and subsequently may aggregate and deliver to the user other series publications of the particular category to which the user might not be subscribed.

Referring again to FIG. 3A, in step 305, identification parameters for the series publication may be gathered. For example, in step 305, the computing device may analyze the headers and/or body of the particular email to determine characteristics that could be used by the computing device in identifying future issues of the series publication, and in some instances, the computing device may prompt the user to confirm that correct identifying characteristics have been determined. Such characteristics may include, for instance, the email address from which the email was sent, the address to which the email was addressed, one or more words used in the email (e.g., in the message body, in the subject line, etc.), the date on which the email was sent, the date on which the email was received, and/or the like. For example, in some arrangements, such identifying characteristics may include an issue number included in the email matching a particular issue numbering scheme, the file names or source uniform resource locators (URLs) of one or more images or other embedded content included in the email, and/or distinguishing graphical features of one or more images included in the email (e.g., as determined based on an analysis of the image data associated with such images).

In step 306, a new data folder such as an email folder, dedicated to the one or more series publications, may be created and associated with the user's account. For example, in addition to the email inbox, one or more other folders and/or sub-folders may be used to sort and/or store emails associated with a particular user. For instance, in addition to an “Inbox” folder, a user also may have a “Sent” folder for storing messages sent by the user, a “Drafts” folder for storing messages written (but not yet sent) by the user, a “Spam” Folder for storing messages deemed to be junk mail by the computing device, and/or a “Trash” folder for storing messages deleted by the user from one or more other folders. In one or more arrangements, a user may also have a “Subscriptions” folder in which emails that include series publications may be stored. In such arrangements, in step 306, the computing device may thus create a sub-folder in the “Subscriptions” folder, for example, and this created sub-folder may be dedicated to one or more particular series publications.

For instance, if a user selects and categorizes a series publication entitled “Daily Candy,” then the computing device may create a sub-folder entitled “Daily Candy” within the “Subscriptions” folder of the user's email inbox, and this sub-folder may be dedicated to storing past, present, and/or future issues of the “Daily Candy” series publication. FIG. 7 illustrates an example user interface 700 in which this example sub-folder 701 has been created. As may also be seen in FIG. 7, after such a dedicated folder is created, a status message 702 may be displayed via the user interface (e.g., user interface 700) to inform the user that the folder has been created and/or that the folder is dedicated to a particular series publication.

Referring again to FIG. 3A, in step 307, it may be determined whether one or more additional emails were selected for categorization in step 303 that have yet to be categorized. If the computing device determines that one or more emails have yet to be categorized, then the computing device may repeat steps 304 to 307 until all of the emails selected in step 303 have been categorized. On the other hand, if there are no more emails to be categorized (or once all of the selected emails have been categorized), the method may proceed to step 308. In some arrangements, the method also may proceed to step 308 if it is determined, in step 301, that a request to view the email inbox was not received and/or if it is determined, in step 303, that the option to subscribe to one or more series publications was not selected.

In step 308, it may be determined whether a request to view a particular email has been received. For example, in step 308, the computing device may determine whether user input corresponding to a request to view a particular email or other selection has been received (e.g., via one or more displayed user interfaces).

If it is determined, in step 308, that a request to view a particular email has been received, then the computing device may perform one or more steps to determine whether the particular email includes a series publication. For example, in step 309, the computing device may load a listing of series publication subscriptions that includes information about the one or more series publications to which the user is subscribed (and/or other series publications), as well as identification parameters and/or other criteria associated with each subscription that enable the computing device to identify particular series publications in messages. In one or more arrangements, this information may be stored locally on the computing device (e.g., in a user's preference settings), while in some arrangements, this information may be stored remotely on a server (e.g., in a user profile stored on an email server).

In step 310, the computing device may evaluate headers associated with the particular email message. For example, the computing device may parse the email message's headers and determine, based on the parsed headers, whether the particular email was sent from an address or server known to be associated with one or more series publications.

In step 311, the computing device may determine whether the email message's headers match up with known information about one or more series publications (e.g., information included in the previously loaded listing of series publication subscriptions, identification parameters, other criteria, etc.), as this may indicate that the email includes a series publication. For example, if in step 310, the computing device determines, based on the parsed headers, that the particular email was sent from an address or server known to be associated with one or more series publications, then in step 311, the computing device may determine that the email message's headers match up with known information about one or more series publications.

If it is determined, in step 311, that the email message's headers do not match up with known information about one or more series publications, then in step 312, the computing device may evaluate the body of the particular email message. For example, the computing device may parse the email message's body and determine, based on the parsed body, whether the particular email includes text, images, and/or other content known to be associated with one or more series publications (e.g., based on previously loaded listing of series publication subscriptions, identification parameters, other criteria, etc.). For instance, the computing device may determine, based on the parsed message body, whether the email includes the words “subscribe” and/or “unsubscribe,” as these words may commonly be indicative of a series publication. Additionally or alternatively, such evaluation may include analyzing any text, images, and/or other content embedded in the headers and/or body of the email (e.g., similar to how such features of an email may be identified and analyzed in gathering identification parameters of an email in step 305).

In step 313, the computing device may determine whether the email message's body matches up with known information about one or more series publications (e.g., information included in the previously loaded listing of series publication subscriptions, identification parameters, other criteria, etc.), as this may indicate that the email includes a series publication. For example, if in step 312, the computing device determines, based on the parsed message body, that the particular email includes text, images, and/or other content that matches up with one or more series publications, then in step 313, the computing device may determine that the email message's body matches up with known information about one or more series publications.

If it is determined, in step 313, that the email message's body matches up with known information about one or more series publications (and/or if it is determined, in step 311, that the email message's headers match up with known information about one or more series publications), then in step 314, the computing device may determine whether the user is subscribed or otherwise has access to the series publication included in the email. For example, having matched the email to a particular series publication in the preceding steps, the computing device may determine what particular series publication is included in the email, whether the user is subscribed to the series publication, and/or in which dedicated folder the email should be placed. In one or more arrangements, the computing device may determine this by comparing the name of the particular series publication with a data table and/or directory tree in which series publication names to which the particular user is subscribed are stored in relation to email folders and/or email handling rules.

If it is determined, in step 314, that the user is subscribed to the series publication included in the email, then in step 315, the computing device may redirect the email to the dedicated folder corresponding to the series publication. On the other hand, if it is determined, in step 314, that the user is not subscribed to the series publication, then in step 316, the computing device may provide the user with the option to subscribe to and categorize the email that includes the series publication. This may include performing one or more of steps 303 to 307, as described above.

Subsequently, in step 317 (FIG. 3B), the computing device may determine whether the email includes a preview, such as a web page preview. The computing device may determine whether the email includes a preview by analyzing the email's content, envelope information, and/or other header information. According to one or more aspects, a web page preview may be additional and/or enhanced content (e.g., audio content, video content, interactive content, etc.) included in sent along with an email, but not necessarily displayed with the other message contents of the email. Rather, the web page preview may, for example, be displayed in response to a user requesting to view more information about the subject of the email and/or in response to a user directly requesting to view the web page preview, as further described below with respect to the subsequent steps of the process. For example, an email that includes a message and/or other information about an upcoming movie may include, as a web page preview, a video trailer for the movie and/or a user interface to purchase tickets for the movie. In another example, an email that a message and/or other information about a new clothing line available from a particular designer may include, as a web page preview, an interactive virtual fitting room in which a user may three-dimensionally view the new clothing and/or purchase and order the same. In each of these examples, the preview may be displayed in a frame or graphical region that is adjacent to, but different from, a frame or graphical region in which the other message contents of the email are displayed. Additionally or alternatively, the preview may be displayed as an overlay, such as an opaque or semi-transparent window that is displayed on top of a display region that includes the other message contents of the email.

If it is determined, in step 317, that the particular email does not include both a message and a web page preview, then in step 318, the email may be displayed. For example, in step 318, the computing device (e.g., personal computer 114) may display via a user interface the email previously selected to be displayed by the user. On the other hand, if it is determined, in step 317, that the particular email does include both a message and a web page preview, then in step 319, the message may be displayed without displaying the web page preview. For example, in step 319, the computing device (e.g., personal computer 114) may display the message, without displaying the web page preview, via a user interface, which may, in some arrangements, indicate that additional preview content is included in the message and/or available to be viewed. According to one or more aspects, such a user interface may resemble example user interface 900, which is illustrated in FIG. 9.

As may be seen in FIG. 9, user interface 900 may include a display of a message in a user's email inbox, as well as a text box 901 which may indicate that the displayed message also includes a web page preview (which is not yet displayed). In the example illustrated in FIG. 9, the displayed message includes a virtual fitting room preview, and a user may access the virtual fitting room preview by selecting (e.g., clicking on) text box 901.

Referring again to FIG. 3B, in step 320, it may be determined whether the user requested to view the web page preview associated with the email. For example, in step 320, the computing device (e.g., personal computer 114) may determine whether user input was received corresponding to a selection of a control on a displayed user interface (e.g., text box 901 of user interface 900) to request that the preview be displayed. If it is determined, in step 320, that the user requested to view the preview associated with the message, then in step 321, the preview may be displayed within the same application in which the message is being displayed (e.g., a mail browser).

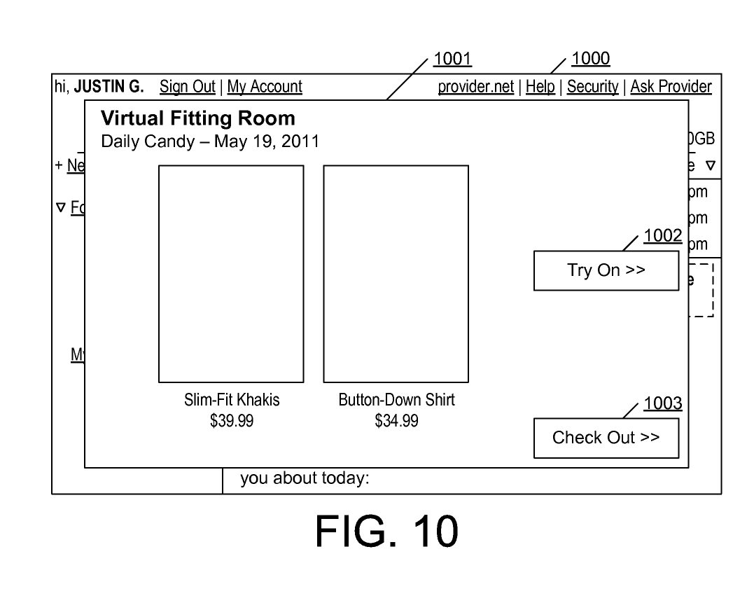

For example, in step 321, the computing device (e.g., personal computer 114) may display the web page preview, via a user interface, within the same application in which the message was previously displayed. According to one or more aspects, such a user interface may resemble example user interface 1000, which is illustrated in FIG. 10. As may be seen in FIG. 10, user interface 1000 may include a preview window 1001 in which the additional and/or enhanced content associated with a preview may be displayed. Via the displayed preview, a user may be able to interact with dynamic content, for instance, to purchase and/or access goods, services, and/or additional content (e.g., on-demand content, video games, etc.). In the example illustrated in FIG. 10, the preview is a virtual fitting room preview in which the user may view various clothing items (e.g., that are related to the email) and/or purchase and order such items (e.g., from the sender of the email). For example, a user may select the try-on button 1002 to three-dimensionally view the clothing items and/or have them displayed on a three-dimensional model of a person, and/or a user may select the checkout button 1003 to purchase and order the items desired by the user. Other types of previews may include video trailers for movies with associated user interfaces for ordering movie tickets, sample audio tracks for newly released albums with associated user interfaces for ordering albums, e-book previews, virtual tours, previews of HTML and/or FLASH content, and/or the like.

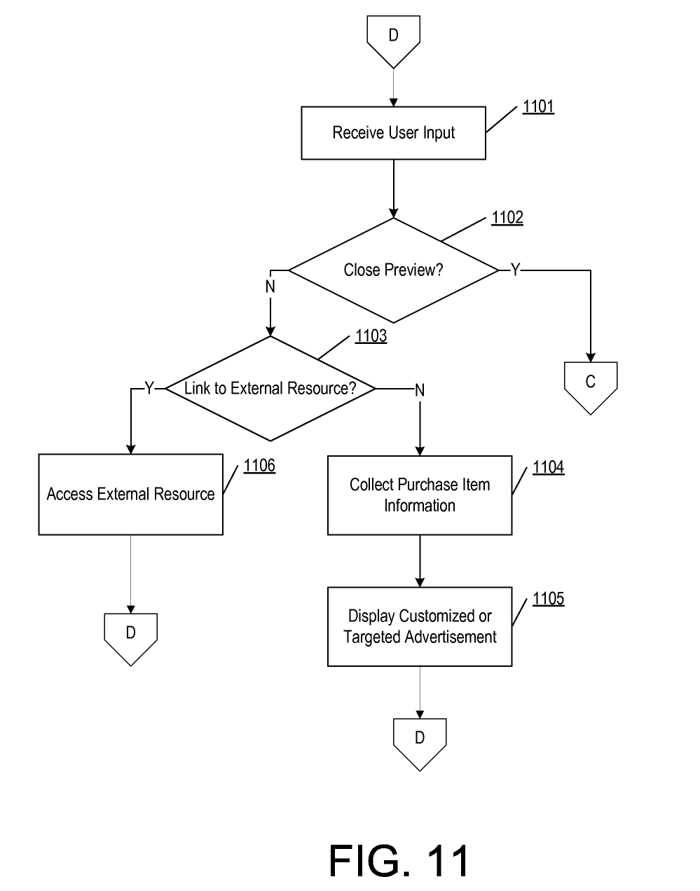

Upon displaying the preview in step 321, a method for controlling the preview may be initiated. That is, the preview may be displayed for a predetermined period of time and then continue with the method of FIG. 3B or may initiate a method for controlling the preview that permits user interaction. FIG. 11 provides one example of a method for controlling the preview. Once the preview is displayed in step 321, the preview continues to be displayed while the computing device awaits a user's input at step 1101. In step 1101, the preview receives a user's input. Thus, the preview may function as a graphical user interface. The user input may be entered by using a mouse to click on a button of the preview, entering text (e.g., letters, numbers, symbols, or any combination thereof) into a field (e.g., a text box) within the preview, speaking into a microphone, touching the screen in an area over a button on the preview, using hand or body gestures, and/or by performing any combination thereof. For example, where the preview includes instructions to provide a plurality of pages (e.g., webpages), buttons within the preview may be pressed (e.g., clicked-on, touched, etc.) to navigate through the plurality of pages. To support such a feature, the message may be sent with executable instructions for presenting an interactive interface within the message preview area. In this manner, a retailer may provide a customized retail experience to the user, without requiring the user to leave the familiar confines of his/her message viewer.

In one or more embodiments, the user inputs may be automatically provided. The computing device may select one or more user inputs to be entered based on the user's profile. In one or more arrangements, the user's profile may include information about the user's content purchasing habits, viewing habits, and/or the like, as well as one or more user preferences that the user may set via one or more menus displayed by the computing device, such as preferences specifying particular interests of the user, favorite programs of the user, favorite channels of the user, and so on. Thus, for instance, in step 1101, the computing device (e.g., personal computer 114) may enter user inputs into fields within the preview by accessing and/or loading information about the user's content viewing habits (e.g., by communicating with a gateway 111, television 112, set top box 113, and/or other device in the premises to access records stored by the other device or devices that indicate the user's content viewing habits, and/or by accessing similar records stored on the computing device itself). In general, user preferences may be stored and made accessible to the preview, so that the preview may pull relevant data. For example, if the preview is an advertisement for a football jersey, the preview may populate a field for entering a specific football team with the user's favorite football team stored in memory that may be accessed by the preview. Further, in some embodiments, the user inputs may be automatically provided based upon a user's content viewing habits.

After an input is received at step 1101, the method proceeds to step 1102. In step 1102, it is determined whether the user's input indicates that the user wishes to discontinue displaying the preview. If the user input does indicate that the user no longer wishes to display the preview, the preview may be closed and the method may proceed to step 322 in FIG. 3B. For example, if the user selects an “x” button in the corner of the window displaying the preview, the preview may be closed. Also, in some embodiments, the user may be prompted after entering an input which indicates that the preview should be closed to confirm that the user's input was not a mistake, before actually closing the preview.

If it is determined that the user's input does not direct the preview to close at step 1102, then the method may proceed to step 1103. In step 1103, it is determined whether the user's input is a selection of a link to an external resource. In other words, step 1103 determines whether the user has selected a link to a resource that is external to the application in which the preview is currently displayed. For example, a message being previewed may have originally been delivered along with data to allow the preview application to generate message content displays and interactive features, and those features would be considered internal to the preview. The preview may also contain, however, a link (e.g., an HTTP hyperlink) to a web page and/or data that was not included in the original previewed message, and that web page or other data may be considered external, and may be accessed using a separate application from the message previewer.

If the input is not a selection of a link to an external resource (No at step 1103), then the user input is analyzed at step 1104 using internal data and/or instructions that were included with the previewed message when it was delivered. For example, the original message may have included instructions and data to display an item available for purchase, and to respond to a user selection of an item (e.g., by touch screen selection, voice input, by clicking on an internal link, etc.) by presenting more information about the product or initiating a purchase. These internal instructions and/or data can be formatted to be processed by the message preview application, such that the preview application is able to interact with the user without requiring that the user leave the preview application. Thus, at step 1104, it may be determined that the user input corresponds to purchase item information, for example, a desired color for a particular item that the user wishes to purchase. After the user input is analyzed in step 1104, the preview can respond to the user's selection in step 1105 by changing the display to present additional information about a selected product, or collecting information from the user to initiate a purchase, or any other desired response as governed by the internal instructions received with the original message. The response may change certain aspects of the display presently shown in the preview according to the user input and/or may provide a new display.

In an example step 1105 of FIG. 11, the response may include executing instructions within the preview to display an advertisement. For example, the response of the preview at step 1105 may entail displaying an offer or advertisement for the item to be purchased in accordance with the purchase item information (e.g., size, color, etc.) analyzed in step 1104. Also, step 1105 may provide a special offer (e.g., goods or services at a special price, two-for-one deals, unique goods/services, etc.) on a new page when the user selects a “next” button to navigate through the preview. In each occurrence of step 1105, the advertisement may change to reflect a user's interests or selections. In this manner, the advertisement may be customized or targeted for the particular user without having to run a separate application. In other words, the preview's response at step 1105 may, for example, permit a user to customize an order within his/her mail browser, before sending the order to a corresponding vendor.

In some embodiments, customization of the preview may be done in response to each individual user input, while in other embodiments, customization may only be performed when the user input indicates that customization should occur. For example, a user may input a color for a t-shirt to be displayed in the preview, but the preview might not be customized to show the t-shirt having that color until the user selects a button (e.g., a “submit” button) indicating that the preview should be customized.

After the preview is customized, the method is re-initiated to await a user's further input. The preview may be customized as many times as desired by the user. In other words, the method of FIG. 11 may be performed any number of times until the user inputs a selection directing the preview to close. For example, steps 1104 and 1105 may be repeated a number of times so that a user may select a number of items to purchase and specify details (e.g., color, size, etc.) of each item. Thus, the user may continue to customize an offer displayed in step 1105, until he/she is ready to accept the offer. Because acceptance of the offer generally involves the transfer of secure payment information, such as credit card information, bank routing information, etc., the user may be directed to a vendor's website to complete the transaction. Alternatively, the preview may contain executable instructions to generate an email that notifies a vendor of the user's acceptance of the offer, including details of the purchase transaction. In some cases, the generated email may automatically fill-in the email address to which the email should be delivered. Also, emails can be automatically generated when users have questions for vendors about a particular item or offer.

If the input is a selection of a link to an external resource (Yes at step 1103), then another application (i.e., an application different than the application used to display the preview) may be initiated to access the data at the destination of the external resource at step 1106. For example, a web browser may be run to access a vendor's web page associated with the link. The web page may be a checkout or shopping cart web page that is populated with the item or service selections collected and displayed in steps 1104 and 1105. Therefore, a user can make his/her selections in the preview and those selections can be exported to an external web page of a specific vendor. This may provide a faster and easier online checkout experience. In some embodiments, the user may be prompted to choose what application is run to access/display the external resource. Meanwhile, the preview may continue to be displayed in its own application (i.e., the mail browser). Thus, the user may return to the preview and further customize the preview or close the preview.

The method illustrated in FIG. 11 may be used for various types of e-commerce or online shopping previews. For example, within the preview, the user may be able to begin customizing a product to be purchased (e.g., a customizable football jersey, a customizable computer, etc.). E-commerce may be facilitated because the computing device does not have to transfer the user from the preview to the merchant's website (which may, for instance, be displayed by a different software application) until the order customization process is complete. That is, because the preview may act as a user interface and may be customized within an email browser, users may be more likely to view and interact with communications sent via email. Additionally or alternatively, e-commerce may be facilitated because the computing device might auto-populate one or more user-fillable fields (in which the user may be able to enter information customizing the product) based on the user's series publication interests. For example, if the user subscribes to a series publication of a particular sports team, the computing device may auto-populate or automatically select that sports team's jersey for the user to customize during the order customization process displayed via a preview in which sports apparel is available for customization and purchase.

In some arrangements, a preview may be displayed (e.g., by the computing device) in a different frame or graphical region from the other message contents, and/or may be displayed as an overlay, as noted above. For example, if a particular message includes a plurality of hyperlinks to various pages and/or websites, the computing device may cycle through displaying, in the area in which the preview is displayed, a thumbnail or other graphical representation of each page or website linked to in the message. For instance, the computing device may display a given thumbnail for a predetermined period of time (e.g., ten seconds) before displaying a thumbnail for the next link included the message. Additionally or alternatively, the area in which the preview is displayed (e.g., the frame, region, or overlay) may include one or more controls, such as a next button and/or a previous button, that allow the user to navigate through the previews.

Subsequently, in step 322, it may be determined whether any new subscription-based offers are available. According to one or more aspects, such subscription-based offers may be invitations to subscribe to one or more series publications (e.g., newsletters of various entities, such as business or advertising partners of a mail service provider). For example, in step 322, the computing device (e.g., personal computer 114) may access a central database (e.g., a database stored on and/or accessible via communication with application server 107) to determine whether any new subscription-based offers have been listed in such database and/or otherwise made available for offering and/or displaying to one or more users. In at least one arrangement, the subscription-based offers that are ultimately displayed to a user may be selected automatically by a computing device based on information about the particular user and/or other users (e.g., other users of the mail service provider), as further described below.

If it is determined, in step 322, that one or more new subscription-based offers are available, then in step 323, it may be determined whether the user is open to receiving new subscription-based offers. For example, the computing device may determine whether the user has previously indicated (e.g., via user preferences) that the user would like to be presented with new subscription-based offers when such offers become available.

If it is determined, in step 323, that the user is open to receiving new subscription-based offers, then in step 324, it may be determined whether the user is already subscribed to any and/or all of the new subscription-based offers. For example, in step 324, the computing device may compare the new subscription-based offers with information (e.g., from a data table and/or the user's profile) about the user's current subscriptions.

If it is determined, in step 324, that the user is not already subscribed to all of the new subscription-based offers, then in step 325, the computing device may select one or more new subscription-based offers to be displayed based on the user's profile. In one or more arrangements, the user's profile may include information about the user's content purchasing habits, viewing habits, and/or the like, as well as one or more user preferences that the user may set via one or more menus displayed by the computing device, such as preferences specifying particular interests of the users, favorite programs of the user, favorite channels of the user, and so on. Thus, for instance, in step 325, the computing device (e.g., personal computer 114) may select a new subscription-based offer to be displayed to a user by accessing and/or loading information about the user's content viewing habits (e.g., by communicating with a gateway 111, television 112, set top box 113, and/or other device in the premises to access records stored by the other device or devices that indicate the user's content viewing habits, and/or by accessing similar records stored on the computing device itself).

In one or more arrangements, these content viewing records may include information about content previously viewed by the user, such as the titles, genres, categories, and/or the like associated with such content, as well as the frequencies at which such content was viewed (e.g., more than once a day, once a day, one or more times every three days, once a week, once every two weeks, once a month, etc.). Subsequently, the computing device may, for instance, determine, based on the content viewing records, whether the user frequently views content that matches up with the one or more categories of the one or more new subscription-based offers. In at least one arrangement, the computing device (e.g., personal computer 114) may make this determination by comparing category information and frequency information about the user's content viewing habits from the content viewing records with category information of the one or more new subscription-based offers. If, for instance, the user views a certain category of content (e.g., televised baseball games) more than once a week, this frequency may be sufficient for the computing device to determine that the user frequently views such content for purposes of selecting a corresponding subscription-based offer to be displayed to the user (e.g., a weekly subscription-based newsletter with baseball news and other baseball-related offers). The computing device may be configured so that any desirable viewing frequency rises to this frequent viewing level, and in some arrangements, different types of programming may be frequently viewed at different rates (e.g., a user may be deemed to frequently view news programming if the user views news programming more than five times a week, but the user also may be deemed to frequently view live football games if the user views such football games more than three times per month).

In one or more additional and/or alternative arrangements, the content viewing records also may include information about content (e.g., television programs) of which the user has scheduled recordings (e.g., using a digital video recording functionality provided by the computing device). In these arrangements, this content which is scheduled for recording may be treated as content that is frequently viewed by the user (e.g., because the user has indicated a desire to view the content by scheduling a recording of such content), and thus the computing device may determine whether such content matches up with the one or more categories of the one or more new subscription-based offers, as in the example above, so as to select one or more of such offers. In still other arrangements, a favorite programs list and/or a favorite channels list (e.g., which may be included in the user's profile and/or specified by one or more user preferences set by the user) may similarly be used in selecting one or more offers. Additionally or alternatively, information about offers that the user previously indicated an interest in (e.g., by clicking through the offer and/or purchasing a product through the offer) may be stored in the user's profile, and this information may similarly be used in selecting one or more offers.

In step 326, the computing device may select one or more new subscription-based offers to be displayed based on other users' selections of subscription-based offers. For example, in step 326, the computing device (e.g., personal computer 114) may select a new subscription-based offer to be displayed to the user based on other users' selections of subscription-based offers by accessing a central database (e.g., a database stored at and/or accessible via application server 107 and/or central office 103) in which information about one or more other user's selections of subscription-based offers is stored. In one or more arrangements, this information may include common preferences (e.g., likes, dislikes, etc.) of different customers broken out by categories (e.g., based on programming and/or content subscription plans), demographics (e.g., based on age), regions (e.g., based on geographic region), and/or the like. Subsequently, the computing device (e.g., personal computer 114) may, for instance, determine whether similar information about the user (e.g., the one or more particular categories, demographics, regions, etc. associated with the user) matches up with similar information about one or more other users. Then, the computing device may determine, for example, whether any of the one or more other users matching the user of the computing device on these bases have subscribed to one or more of the new subscription-based offers available to the user. If, in this example, these matching users have subscribed to one or more of these new offers, then the computing device may select (to be displayed to the user) the one or more new offers subscribed to by the other users.

In one or more additional arrangements, the other users against which the user may be compared (e.g., for purposes of determining what new subscription-based offers to select to be displayed to the user) may be users with which the user has established some association via a social networking service. For example, if the computing device (e.g., personal computer 114) determines that one or more of the user's “friends” on the social networking service (or some particular percentage thereof, e.g., more than thirty percent of the user's friends) have subscribed to one or more of the new subscription-based offers available in the foregoing steps, then the computing device may select, in step 326, such offers to be displayed to the user. Additionally or alternatively, the one or more networks and/or one or more groups that the user is a member of may be used by the computing device in determining what new subscription-based offers to select to be displayed to the user (e.g., one or more offers may be selected based on the nature of these groups and/or networks alone and/or based on the preferences of other individuals in these networks and/or groups). In some arrangements, the likes and/or dislikes (as indicated via the social networking service) of the user and/or the other individuals in the user's networks and/or groups also may be accounted for by the computing device in selecting one or more offers. For example, if the user or a plurality of users in the user's groups and/or networks dislikes a particular brand or product, as indicated via likes and dislikes determined via the social network, then the computing device might not select offers related to that particular brand or product.

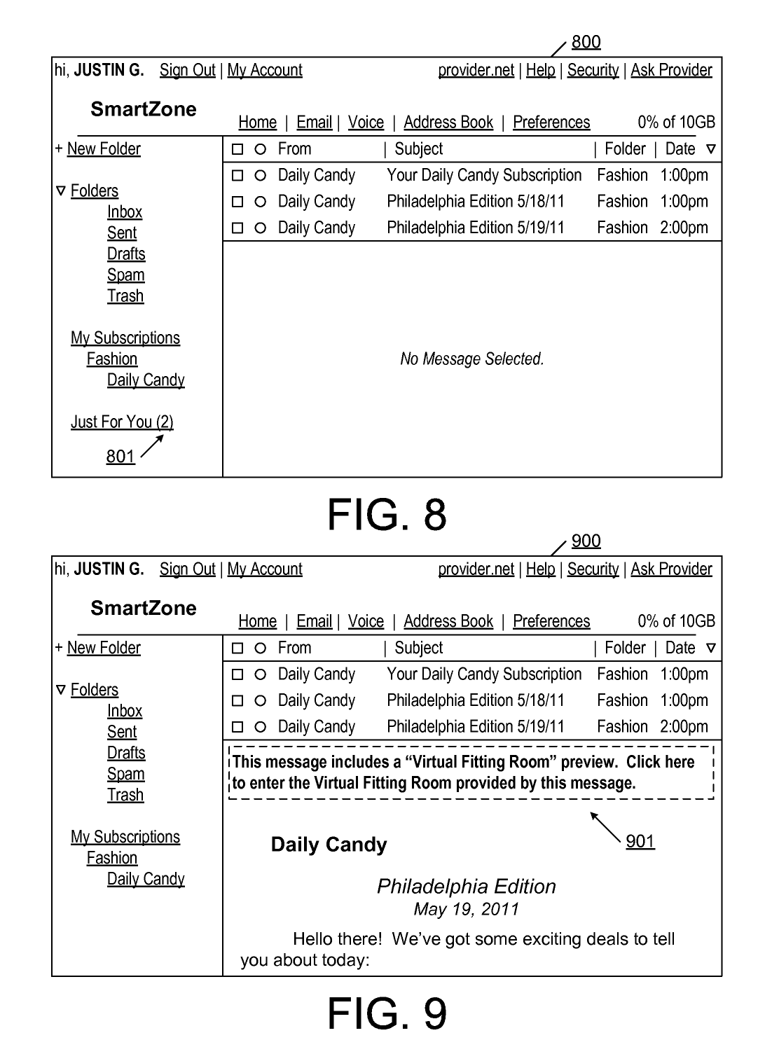

In step 327, an indication of the offers selected (e.g., in steps 325 and 326) may be displayed. For example, in step 325, the computing device (e.g., personal computer 114) may display an indication, such as a text box, via a user interface that informs the user that one or more new subscription-based offers are available and/or have been selected for the user. According to one or more aspects, such a user interface may resemble example user interface 800, which is illustrated in FIG. 8.

As may be seen in FIG. 8, user interface 800 may include a text box 801 in which the indication of step 327 may be displayed. In the example illustrated in FIG. 8, text box 801 indicates the number of new subscription-based offers that are available and/or that have been selected for the user (e.g., two such offers in this example). In one or more alternative arrangements, the indication of step 327 may be displayed in other forms (e.g., the one or more new subscription-based offers that are available and/or have been selected for the user may be listed by name under the “My Subscriptions” heading or the “Just For You” heading seen in user interface 800).

Aspects of the disclosure have been described in terms of illustrative embodiments thereof. While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. Any of the above described systems and methods or parts thereof may be combined with the other methods and systems or parts thereof described above. Any and/or all of the methods described herein may be embodied as computer-executable instructions stored on a computer-readable medium. In addition, the steps illustrated in the illustrative figures may be performed in other than the recited order, and one or more steps illustrated may be optional or other steps may be added in accordance with aspects of the disclosure. It will also be appreciated and understood that modifications may be made without departing from the true spirit and scope of the present disclosure. The description is thus to be regarded as illustrative instead of restrictive on the present disclosure.

What is claimed is:

1. A method, comprising:
displaying a plurality of incoming emails from a first user's inbox;
displaying an option to designate an email as a series publication;
in response to receiving a selection of the option while at least one email is selected, automatically creating a new email folder dedicated to a series publication contained in the at least one email; and
redirecting subsequent emails containing future issues of the series publication to the new email folder.

2. The method of claim 1, further comprising:
determining that a second email contains a second series publication by comparing header information of the second email with series publication information stored on a remote server.

3. The method of claim 2, wherein the series publication information includes information about series publication preferences of one or more other users different from the first user.

4. The method of claim 1, wherein the option to designate an email as a series publication is displayed in response to determining that data contained in the email is a series publication to which the user is not subscribed.

5. The method of claim 1, further comprising:
prior to automatically creating the new email folder, prompting the user to categorize the series publication.

6. The method of claim 1, further comprising:
receiving a second email that includes a message and a preview;
upon receiving a selection of the second email, displaying the message without displaying the preview; and
upon receiving a request to display the preview, displaying the preview without exiting a mail browser in which the message and the preview are displayed.

7. The method of claim 1, further comprising:
displaying an indication of the number of new subscription-based offers in the first user's inbox.

8. The method of claim of claim 7, further comprising:
prior to displaying the indication, selecting, based on the first user's content viewing habits, the one or more new subscription-based offers to be displayed.

9. The method of claim 1, further comprising:
displaying, to a second user different from the first user, one or more subscription-based offers that were previously flagged by the first user.

10. At least one non-transitory computer-readable medium having computer-executable instructions stored thereon that, when executed, cause at least one processor to:
display a plurality of incoming emails from a user's inbox;
access an email that includes a message and a preview;
display an option to view the preview; and
in response to receiving a selection of the option to view the preview while the email is selected, display the preview contained in the email without exiting a mail browser in which the message and the preview are displayed.

11. The at least one non-transitory computer-readable medium of claim 10, having additional computer-executable instructions stored thereon that, when executed, further cause the at least one processor to:
before displaying the option to view the preview, determine whether the email includes a preview by analyzing the email's content, envelope information, header information, or any combination thereof.

12. The at least one non-transitory computer-readable medium of claim 11, having additional computer-executable instructions stored thereon that, when executed, further cause the at least one processor to:
receive a user input, which is input into the preview.

13. The at least one non-transitory computer-readable medium of claim 10, having additional computer-executable instructions stored thereon that, when executed, further cause the at least one processor to:
if the user input is a selection of a link to an external resource, initiate a second application to access the external resource.

14. The at least one non-transitory computer-readable medium of claim 13, wherein the second application includes a web browser, the external resource includes a web page, and the link includes an HTTP hyperlink to the web page.

15. The at least one non-transitory computer-readable medium of claim 10, having additional computer-executable instructions stored thereon that, when executed, further cause the at least one processor to:
customize the preview within the mail browser in which the preview is displayed based upon the user input.

16. The at least one non-transitory computer-readable medium of claim 15, wherein the user input is automatically entered into the mail browser based on user preferences.

17. The at least one non-transitory computer-readable medium of claim 16, wherein the user preferences are based on the user's content viewing habits or series publication interests.

18. The at least one non-transitory computer-readable medium of claim 10, wherein the preview is displayed within the mail browser in a different frame or graphical region from the message, and the preview comprises one of a web page, video content, audio content, audio-video content, text, images, and FLASH content.

19. An apparatus, comprising:
at least one processor; and
memory storing computer-readable instructions that, when executed by the at least one processor, cause the apparatus to:
display a plurality of incoming emails from a user's inbox;
display an option to designate an email as a series publication;
in response to receiving a selection of the option while at least one email is selected, automatically create a new email folder dedicated to a series publication contained in the at least one email; and
redirect subsequent emails containing future issues of the series publication to the new email folder.

20. The apparatus of claim 19, wherein the memory additionally stores computer-readable instructions that, when executed by the at least one processor, further cause the apparatus to:
display a preview contained in the email within a mail browser used to display the user's inbox; and
customize the preview within the mail browser based upon an input entered into the preview,
wherein the input is automatically entered into the mail browser based on user preferences determined according to series publication interests of the user.
